(19) United States
(12) Patent Application Publication
(10) Pub. No.: US 2007/0171628 A1
(43) Pub. Date: Jul. 26, 2007

(54) Baseball style cap with amplified stereo speakers

(76) Inventor: John G. Seade, La Mirada, CA (US)

Correspondence Address: HOWARD A KENYON -- PATENT AGENT, 19620 SOUTH JEFFREY CIRCLE, CERRITOS, CA, 90703, US

(21) Appl. No.: 11/337,993

(22) Filed: Jan. 25, 2006

(51) Int. Cl. F21V 21/084

(52) U.S. Cl. 362/106; 362/253

(57) ABSTRACT

The present invention is described as a baseball style cap, having a crown, a brim, an internal sweatband, and two amplified stereo speakers mounted on each side of the brim. The speakers are mounted with the diaphragm pointed downwards. Behind the front of the crown are located battery holder and 4 AAA batteries. There are wires that connect the battery holder to the amplifier. Also there are wires connecting the amplifier to the speakers. A Stereophonic music generator sends a music signal which is provided to the amplifier by any suitable means of communication, like an audio cord or wireless by means of infrared or Bluetooth wireless technology.

### BACKGROUND OF THE INVENTION

1. Field of the Invention

The present invention relates to combined headgear and electronic means to provide music. More specifically, the invention relates to a combined baseball type cap and music signal provided to the speakers attached to the cap.

2. Description of the Prior Art

The combination of a radio providing music signals to a speaker in a cap brim is known. One such combination is U.S. Design Pat. 321,581, dated Nov. 19, 1991 to Shing-Lam Li, Tuen Mun, Hong Kong, and assigned to Antibes, Inc. Monrovia, Liberia. This Design Patent shows a combined cap and radio with a radio antenna attached. This patent has expired.

Another combined headgear and electronic receiving device is U.S. Pat. No. 5,410,746, dated Apr. 25, 1955 to Gelber and assigned to Unatech Corp., New City, N.Y. This patent provides headgear such as a cap, a built in radio, earplugs. This patent has no speakers and no amplifier.

Applicant is not limited to a radio, but uses from a variety of devices. These include but are not limited to IPOD, compact disc player, MP3 player, AM/FM radio. Devices are worn on the belt of the user or attached somewhere on the user's clothing. In addition, a volume control is provided by the music signal generator. The present invention provides a battery holder, an amplifier with an off/on switch, LCD light, and audio jack. There a two speakers that attached to the brim. With the speaker diaphragms pointed downward. These speakers are mounted through the brim with wires connected to the amplifier and the amplifier to the battery holder. Music signal is sent by music generator provider to amplifier by suitable means of communication, like an audio cord or wireless by means of infrared or Bluetooth wireless technology.

A need exists where a person playing music with the present invention can share their music with, and to communicate with others, this cannot be done with earplugs or earphones. It is also known that earplugs or earphones can cause damage to the wearers hearing. The present invention is not harmful to the wearers hearing and the wearer can also hear surrounding sounds such a emergency vehicles.

### BRIEF SUMMARY OF THE INVENTION

Accordingly, it is the object of the present invention to provide a method of listing to music while wearing a baseball style cap and not obstructing their hearing.

It is another object of the present invention to be able to have others enjoy the music generated.

It is another object of the present invention to provide speakers attached to the brim of a baseball style cap.

It is still another object of the present invention to be able to adapt any music signal generator such as an IPOD, compact disc player, MP3 player, AM/FM radio. Briefly, in accordance with the present there is provided a baseball style cap, having a brim with two speakers attached, and a battery holder with batteries, and amplifier being attached to the cap, wires from the battery holder provide power to the amplifier and the amplifier provides music signals to the speakers. A music signal generator communicating to the amplifier by means of an audio cable or wireless by means of infrared or Bluetooth wireless technology from devices such as an IPOD, compact disc player, MP3 player, AM/FM radio.

These together with other objects on the invention, along with various features of novelty that characterize the invention, are pointed out with particularity in the Claims annexed to and forming a part of this disclosure. For better understanding of the invention, its operating advantages and its specific objects obtained by its uses, references should be made to the accompanying drawing and description matter in which there is illustrated Preferred Embodiments of the Invention.

### BRIEF DESCRIPTION OF THE DRAWINGS

FIG. 1 is a perspective view of the combined baseball style cap showing the low profile micro-miniature speakers, amplifier, and battery holder.

FIG. 2 is a bottom view of the combined baseball style cap showing the speakers battery holder and amplifier.

FIG. 3 is a side view of the baseball style cap showing the amplifier with off/on switch, LED light, and audio jack. Also shown are speaker and battery holder.

FIG. 4 is a side view showing battery holder and speaker.

### DESCRIPTION OF THE EMBODIMENT

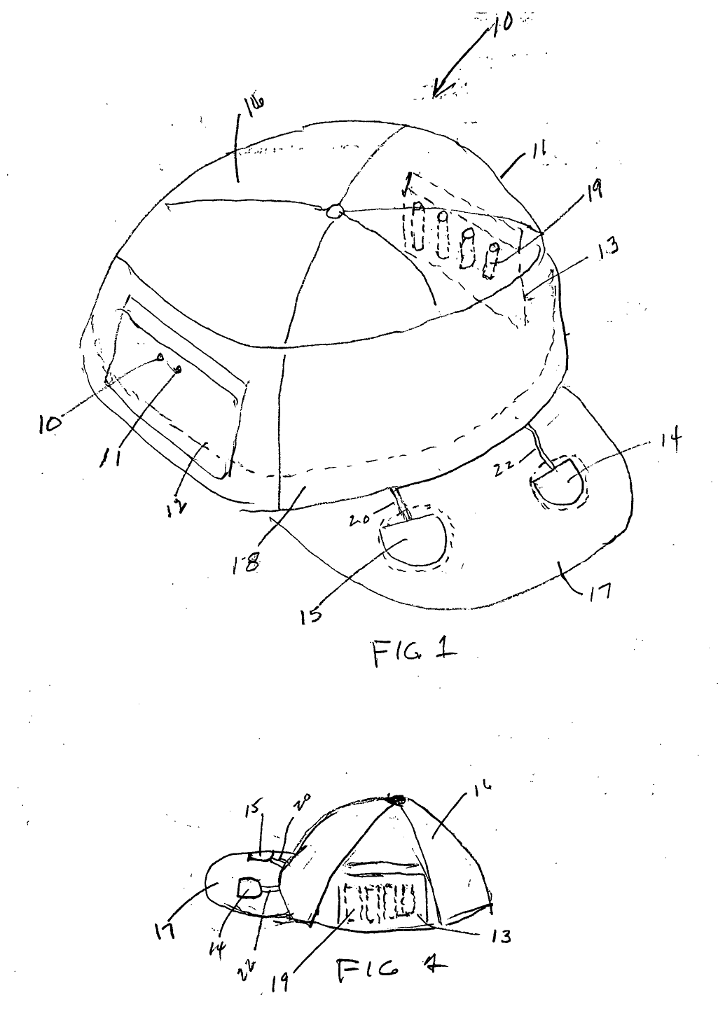

Referring to FIG. 1, there is shown a combined baseball style cap and stereo cap system designed by the reference numeral 25. The combined unit 16 includes a crown 16a, an amplifier 12, a battery holder 13 with the batteries 19 in phantom, and stereo low profile micro-miniature speakers 14 and 15 attached to brim/bill 17. The cap my be of any conventional design and manufacture and includes a cap crown 16a, a brim 17 and a peripheral sweatband or flap 18, as is conventional, only one edge of the sweatband or flap is sewn to the crown enabling the sweatband of flap to be pulled away from the crown to enable access to the inner surface. This enables the wires from the battery holder 13 to allow threading in the sweatband or flap 18 to the amplifier 12. This also allows wires form the amplifier 12 to the speakers 14 and 15. The on/off switch 10 of the amplifier 12 is also shown in this view as the LED light 11 that when illuminated indicates that the amplifier is turned on.

The speakers used in the present invention are what is known as “low profile micro miniature speakers” with rare earth magnets.

FIG. 2 shows a bottom view of the combined baseball style cap stereo speakers, they are enclosed by the cloth that covers the brim/bill, during assembly. As shown in this view is the battery holder 13, the amplifier 12, the sweatband or flap 18 and the cap crown 16a. The brim/bill 17 that contains the two speakers 14 and 15 is also shown.

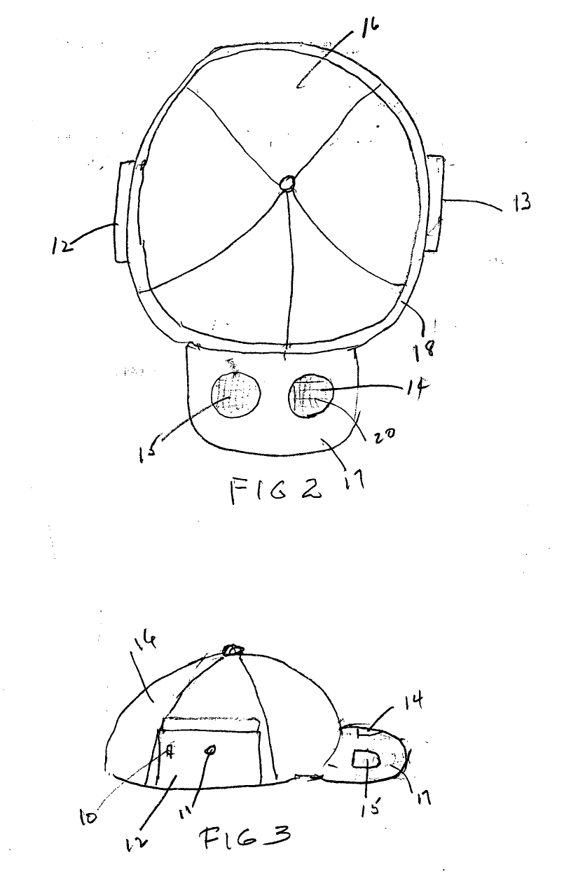

FIG. 3 is a right side view of the combined baseball style cap 16 and stereo speaker 15 showing the amplifier 12, the on/off switch 10, audio stereo jack 10a, and the LED light 11 that when illuminated indicates when the amplifier 12 is turned on. FIG. 3 also shows the brim/bill 17, the connecting wire 20, and speaker 15. Crown 16a also shown in this view.

FIG. 4 is a left side view of the combined baseball style cap 16 and stereo speaker 14, also showing the battery holder 13 with the batteries 19 in phantom. In this view there is also seen brim/bill 17 and the top of the stereo speaker 14. The wires 22 connecting speaker 14 is also seen in this view.

What is claimed is:

1. A baseball style cap having amplified stereo speakers comprising:
A cap having a vertical extending crown with an inner surface facing the head of the user, said crown having a first side facing one side of the head of the user and said crown having a second side facing the opposite side of the head of the user;
A horizontal extending brim/bill, said brim/bill being attached to said crown between said first and said second side;
A sweatband or flap secured to said crown by one edge, said sweatband or flap facing the head of the user,
A battery holder and batteries placed inside said crown of cap
An amplifier placed in said sweatband or flap.

2. A baseball style cap as described in claim 1 having amplified stereo speakers wherein said brim/bill contains two speakers, each speaker being mounted on opposite sides of the brim/bill, the speakers being mounted through the brim/bill material, said speakers having the diaphragm pointed downward, said speakers secured on the brim/bill of said baseball style cap.

3. A baseball style cap as described in claim 2 having amplified stereo speakers wherein said speakers are connected by wire means to said amplifier, said amplifier being placed in said second pocket.

4. A baseball style cap as described in claim 2 having amplified stereo speakers wherein said battery holder is connected to said amplifier by wire means, said battery holder being placed inside said second pocket.

5. A baseball style cap as described in claim 4 having amplified stereo speakers wherein said amplifier has on/off switch located on the side of said amplifier, said on/off switch protruding through the bottom right side of crown.

6. A baseball style cap as described in claim 5 wherein said amplifier contains a LED light protruding through the front of said crown, said LED light illuminates a blue light when said on/off switch is turned on.

7. A baseball style cap as described in claim 3 wherein said amplifier has a said wire means to connect to said battery holder and batteries.

8. A baseball style cap as described in claim 1 wherein said amplifier has a female stereo audio jack connector, said female stereo audio jack connector is designed to receive a music signal from a music signal generator having a male connector.

9. A baseball style cap as described in claim 8 wherein a signal generator having stereo audio cable means, said stereo audio cable means having a male connector to fit in said female stereo audio jack connector on said amplifier.

10. A baseball style cap as described in claim 9 wherein a stereophonic signal must be provided for said amplified stereo speakers the provide stereophonic music.

11. A baseball style cap as described in claim 10 wherein said music signal generator can be an IPOD, compact disc player, MP3 player, AM/FM radio, and any device with a 3.5 mm jack or any other device that can provide stereophonic music signal.

12. A baseball style cap as described in claim 11 wherein said music signal generator will provide volume control means.
